(19) United States
(12) Patent Application Publication
(10) Pub. No.: US 2021/0183590 A1
(43) Pub. Date: Jun. 17, 2021

(54) AUTOMATIC DISCONNECTION MECHANISM FOR SWITCHES

(71) Applicant: Gang Wang, Beijing (CN)

(72) Inventor: Gang Wang, Beijing (CN)

(21) Appl. No.: 16/835,353

(22) Filed: Mar. 31, 2020

(30) Foreign Application Priority Data
Dec. 11, 2019 (CN) 201911263204.3

(51) Int. Cl. H01H 9/20

(52) U.S. Cl. CPC H01H 9/20; H01H 2300/018

(57) ABSTRACT

The invention discloses an automatic disconnection mechanism for switches, comprising a shell, wherein the inside of the shell is hollow, and the shell is provided with a spindle, a cam sleeved on the spindle, a rotary ratchet sleeved on the spindle, a torsional spring sleeved on the spindle, a control ratchet needle that mates with the rotary ratchet, and a limiting mechanism for limiting the rotation range of the cam. The automatic disconnection mechanism of the invention enables the inverter circuit system to remotely disconnect the inverter system circuit without manual operation when it encounters special conditions such as overload and short circuit, which avoids accidents such as burnout of the inverter caused by circuit overload and short circuit and improves the safety of the operator. The automatic disconnection mechanism of the invention and the photovoltaic switch are installed together as an automatic disconnection system for the photovoltaic switch.

### BACKGROUND OF THE INVENTION

### 1. Field of the Invention

The invention relates to the technical field of circuit protection, in particular to an automatic disconnection mechanism for switches.

### 2. Description of the Related Art

With the extensive construction of power systems in China, the safety of power systems has gradually become a concern of the general public and has become a hot issue in the industry in recent years. In particular, DC switches are used in inverters to control the working states of multiple core components. The reliability of DC switches is not only related to the good operation of the entire power system, but also to the stable development of the power industry.

Looking back on the development of the photovoltaic industry in the past few years, the industry has gradually established standards for the use of photovoltaic switches. Major manufacturers have also been researching to enhance the ability of arc extinction for switch contacts and the speed of disconnection for switches. However, the knob-type isolation switch currently used in the market is basically manually operated, and the operator needs to manually disconnect the switch after a fault is found, which undoubtedly increases the safety risk for the operator. At the same time, it cannot achieve automatic and rapid disconnection when encountering problems, which easily causes inverter burnout and fire and seriously threatens the safe operation of photovoltaic power plants. Therefore, when a problem occurs in the circuit, how to quickly cut off the DC switch has become an urgent problem for those skilled in the technical field of photovoltaic system.

### SUMMARY OF THE INVENTION

In order to solve the technical issues above, the invention provides the technical solutions as follows: an automatic disconnection mechanism for switches, comprising a shell, wherein the inside of the shell is hollow, and the shell is provided with a spindle, a cam sleeved on the spindle, a rotary ratchet sleeved on the spindle, a torsional spring sleeved on the spindle, a control ratchet needle that mates with the rotary ratchet, and a limiting mechanism for limiting the rotation range of the cam; the spindle penetrates the shell and is integrated with the switch shaft; the cam is fixedly connected to the spindle, and one end surface thereof is provided with a guide pin; the rotary ratchet is disposed on a side of the cam on which the guide pin is provided and mates with the hole of the spindle; the torsional spring is disposed on a side of the rotary ratchet and enables the torsional spring to be in a tightened state when the spindle rotates clockwise with the switch shaft; the control ratchet needle is disposed on a side of the rotary ratchet; the control ratchet needle comprises a lock plate and a release plate, and the connection portion of the lock plate and the release plate is sleeved on a short shaft fixedly connected to the shell; the lock plate is arranged corresponding to the outer teeth of the outer edge of the rotary ratchet, so that when the spindle rotates clockwise with the switch shaft, the rotary ratchet is fixed and locked by the lock plate; both sides of the release plate are also provided with a trigger mechanism for impacting the release plate to move the lock plate away from the rotary ratchet and eventually disengaging from the rotary ratchet, and a reset mechanism for returning the release plate to the original position after being impact by the trigger mechanism.

As an improvement, the shell is rectangular parallelepiped, the front end surface thereof is provided with a first cover that mates with the shell, and the rear end surface thereof is provided with a second cover that mates with the shell; the second cover is provided with a second hole that mates with the hole of the spindle.

As an improvement, the rotary ratchet is provided with external teeth that mates with the control ratchet needle on the outer periphery; the rotary ratchet is provided with a long elliptical hole that mates with the guide pin, and the corresponding angle of the long elliptical hole is 10°.

As an improvement, the connection portion of the lock plate and the release plate is provided with a connection shaft hole, and the connection shaft hole is sleeved on the short shaft connected to the shell so that the control ratchet needle can rotate around the short shaft; the length of the lock plate is shorter than that of the release plate, and an included angle is arranged between the lock plate and the release plate, and the included angle is an obtuse angle.

As an improvement, the limiting mechanism is a long elliptical bulge; one end of the torsional spring is connected to the shell and the other end thereof is fixedly connected to the cam; the reset mechanism is a reset cam that rotates around a reset shaft, and one end of the reset shaft is connected to the shell and the other end thereof protrudes from the shell; the trigger mechanism is a flux transformer; the shell is further provided with a microswitch, and the microswitch is disposed on a side of the reset mechanism close to the lock plate; a first interlock knob is connected to the spindle protruding from the shell, and a second interlock knob is connected to the end of the reset shaft protruding from the shell.

As an improvement, the limiting mechanism is a brake spring tab; one end of the torsional spring is connected to the shell and the other end thereof is fixedly connected to the cam; the spindle is fixedly connected to the pin of the rotary ratchet; the reset mechanism is a reset spring; the trigger mechanism is an impact electromagnet.

As an improvement, the limiting mechanism is a long elliptical bulge; the spindle is connected to the gear of the rotary ratchet; one end of the torsional spring is connected to the shell and the other end thereof is fixedly connected to the spindle; the reset mechanism is a reset spring; the trigger mechanism comprises a motor, a trigger cam connected to the motor, and a push rod connected to the trigger cam; the outside of the push rod is provided with a frame for fixing the push rod, the frame is fixedly connected to the shell, and the inside of the frame is provided with a trigger spring sleeved on the push rod; the shell is further provided with a microswitch, and the microswitch is disposed on a side of the reset mechanism close to the lock plate.

As an improvement, the limiting mechanism is a long elliptical bulge; the spindle is connected to the gear of the rotary ratchet; one end of the torsional spring is connected to the shell and the other end thereof is fixedly connected to the cam; the reset mechanism is a reset cam that rotates around a reset shaft, and one end of the reset shaft is connected to the shell and the other end thereof protrudes from the shell; the trigger mechanism is an impact electromagnet; the microswitch is disposed on a side of the reset mechanism close to the lock plate; a first interlock knob is connected to the spindle protruding from the shell, and a second interlock knob is connected to the end of the reset shaft protruding from the shell.

As an improvement, the reset mechanism is a side wall reset button corresponding to an end of the release plate of the control ratchet needle away from the lock plate; the side wall reset button is arranged in the same direction as the trigger mechanism and one end thereof protrudes from the shell; the side wall reset button is sleeved with a side wall reset spring connected to the corresponding inner wall of the shell, so that the side wall reset button is returned to its original position under the action of the reset spring after the side wall reset button is pressed in the direction of the trigger mechanism.

As an improvement, the reset mechanism is a reset rotary handle that rotates around a reset shaft; a top reset button on a side of the reset rotary handle away from the trigger mechanism is provided in parallel with the spindle and protrudes from the top of the shell; the top reset button is provided with an inverted triangle driving block corresponding to the reset rotary handle; a top reset spring is also sleeved on the bottom of the top reset button, so that after the top reset button is pressed in its setting direction, the inverted triangle drive block dials the reset rotary handle to rotate toward the trigger mechanism and enables the top reset button to be returned to its original position under the action of the top reset spring.

Compared with the prior technology, the invention has the following advantageous effects:

The automatic disconnection mechanism of the invention enables the inverter circuit system to remotely disconnect the inverter system circuit without manual operation when it encounters special conditions such as overload and short circuit, which avoids accidents such as burnout of the inverter caused by circuit overload and short circuit and improves the safety of the operator. The automatic disconnection mechanism of the invention and the photovoltaic switch are installed together as an automatic disconnection system for the photovoltaic switch.

### BRIEF DESCRIPTION OF THE DRAWINGS

FIG. 1 is a schematic view illustrating the structure of the automatic disconnection mechanism for switches of the invention.

FIG. 2 is a schematic view illustrating the structure of Embodiment 1 of the automatic disconnection mechanism for switches of the invention.

FIG. 3 is a schematic view illustrating the structure of Embodiment 2 of the automatic disconnection mechanism for switches of the invention.

FIG. 4 is a schematic view illustrating the structure of Embodiment 3 of the automatic disconnection mechanism for switches of the invention.

FIG. 5 is a schematic view illustrating the structure of Embodiment 4 of the automatic disconnection mechanism for switches of the invention.

FIG. 6 is a schematic view illustrating the structure of the first cover of the automatic disconnection mechanism for switches of the invention.

FIG. 7 is a schematic view illustrating the structure of the second cover of the automatic disconnection mechanism for switches of the invention.

FIG. 8 is a schematic view illustrating the structure of the rotary ratchet of the automatic disconnection mechanism for switches of the invention.

FIG. 9 is a schematic view illustrating the structure of the control ratchet needle of the automatic disconnection mechanism for switches of the invention.

FIG. 10 is a schematic view illustrating the structure of Embodiment 5 of the automatic disconnection mechanism for switches of the invention.

FIG. 11 is a schematic view illustrating the structure of Embodiment 6 of the automatic disconnection mechanism for switches of the invention.

In the figures, 1 refers to the shell; 1.1 refers to the first cover; 1.2 refers to the second cover; 1.21 refers to the second hole; 1.3 refers to the limiting mechanism; 1.31 refers to the bulge; 1.32 refers to the brake spring tab; 2 refers to the spindle; 3 refers to the cam; 3.1 refers to the guide pin; 4 refers to the rotary ratchet; 4.1 refers to the long elliptical hole; 5 refers to the torsional spring; 6 refers to the control ratchet needle; 6.1 refers to the short shaft; 6.2 refers to the release plate; 6.3 refers to the lock plate; 6.4 refers to the connection shaft hole; 7 refers to the reset mechanism; 7.1 refers to the reset cam; 7.2 refers to the reset shaft; 7.3 refers to the reset spring; 7.4 refers to the side wall reset button; 7.5 refers to the side wall reset spring; 7.6 refers to the reset rotary handle; 7.7 refers to the top reset button; 7.8 refers to the inverted triangle driving block; 7.9 refers to the top reset spring; 8 refers to the trigger mechanism; 8.1 refers to the motor; 8.2 refers to the trigger cam; 8.3 refers to the push rod; 8.4 refers to the trigger spring; 8.5 refers to the frame; 8.6 refers to the flux transformer; 8.7 refers to the impact electromagnet; 9 refers to the microswitch; 10 refers to the first interlock knob; 11 refers to the second interlock knob.

### DETAILED DESCRIPTION OF THE PREFERRED EMBODIMENTS

### Embodiment 1

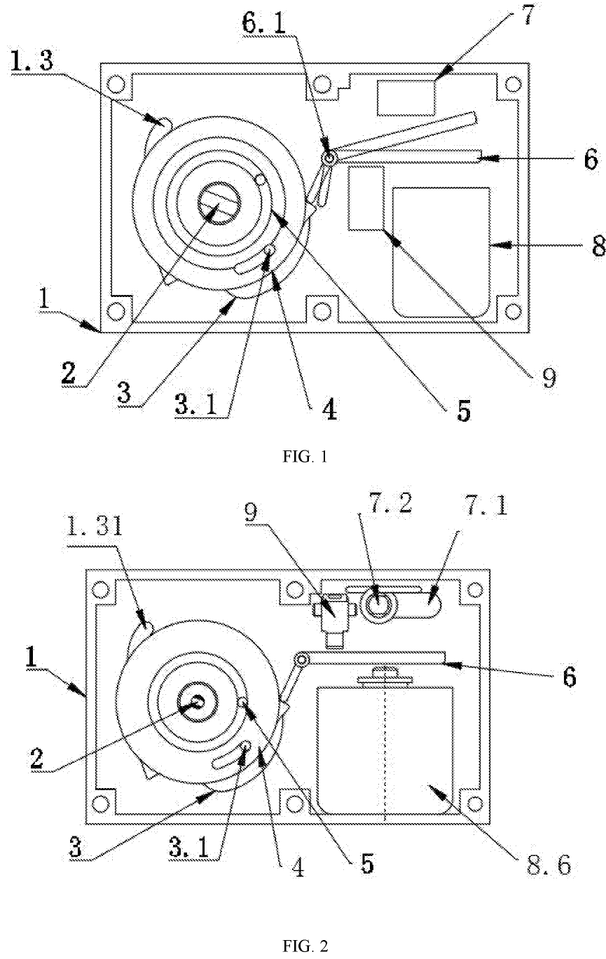

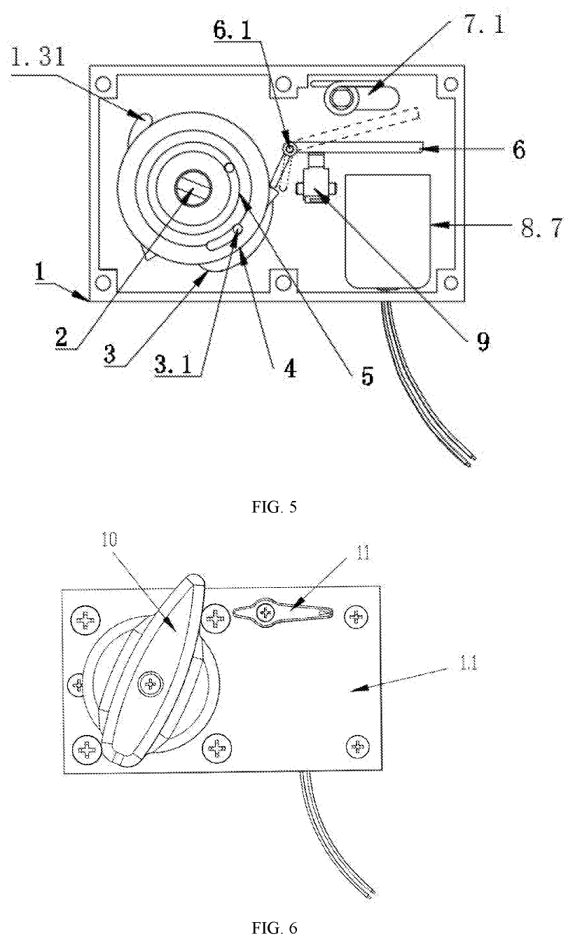

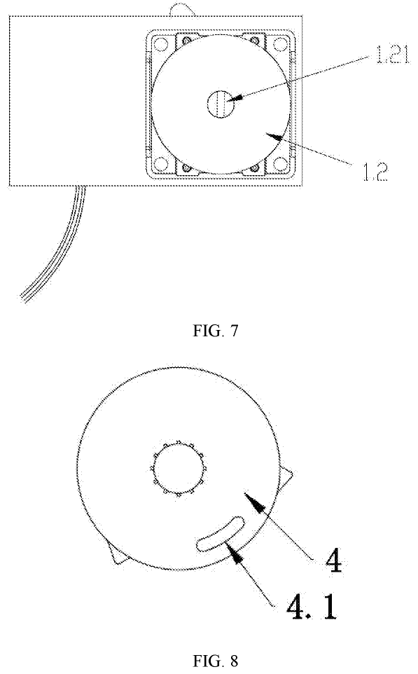

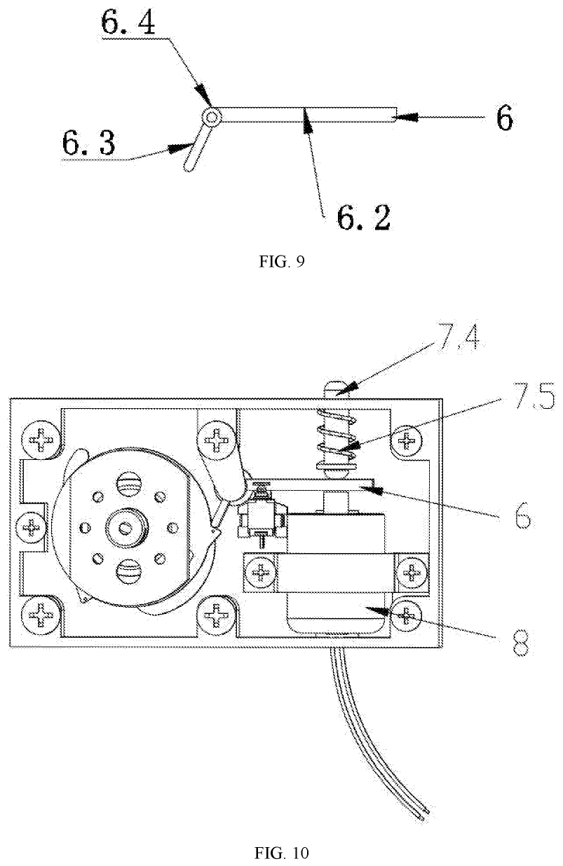

With reference to FIGS. 1, 2, and 6-9, an automatic disconnection mechanism for switches, comprising a shell 1, wherein the inside of the shell 1 is hollow, and the shell 1 is provided with a spindle 2, a cam 3 sleeved on the spindle 2, a rotary ratchet 4 sleeved on the spindle 2, a torsional spring 5 sleeved on the spindle 2, a control ratchet needle 6 that mates with the rotary ratchet 4, and a limiting mechanism 1.3 for limiting the rotation range of the cam 3; the spindle 2 penetrates the shell 1 and is integrated with the switch shaft; the cam 3 is fixedly connected to the spindle 2, and one end surface thereof is provided with a guide pin 3.1; the rotary ratchet 4 is disposed on a side of the cam 3 on which the guide pin 3.1 is provided and mates with the hole of the spindle 2; the torsional spring 5 is disposed on a side of the rotary ratchet 4 and enables the torsional spring 5 to be in a tightened state when the spindle 2 rotates clockwise with the switch shaft; the control ratchet needle 6 is disposed on a side of the rotary ratchet 4; the control ratchet needle 6 comprises a lock plate 6.3 and a release plate 6.2, and the connection portion of the lock plate 6.3 and the release plate 6.2 is sleeved on a short shaft 6.1 fixedly connected to the shell 1; the lock plate 6.3 is arranged corresponding to the outer teeth of the outer edge of the rotary ratchet 4, so that when the spindle 2 rotates clockwise with the switch shaft, the rotary ratchet 4 is fixed and locked by the lock plate 6.3; both sides of the release plate 6.2 are also provided with a trigger mechanism 8 for impacting the release plate 6.2 to move the lock plate 6.3 away from the rotary ratchet 4 and eventually disengaging from the rotary ratchet 4, and a reset mechanism 7 for returning the release plate 6.2 to the original position after being impact by the trigger mechanism 8.

Preferably, the shell 1 is rectangular parallelepiped, the front end surface thereof is provided with a first cover 1.1 that mates with the shell, and the rear end surface thereof is provided with a second cover 1.2 that mates with the shell; the second cover 1.2 is provided with a second hole 1.21 that mates with the hole of the spindle 2.

Preferably, the rotary ratchet 4 is provided with external teeth that mates with the control ratchet needle 6 on the outer periphery; the rotary ratchet 4 is provided with a long elliptical hole 4.1 that mates with the guide pin 3.1, and the corresponding angle of the long elliptical hole 4.1 is 10°.

Preferably, the connection portion of the lock plate 6.3 and the release plate 6.2 is provided with a connection shaft hole 6.4, and the connection shaft hole 6.4 is sleeved on the short shaft 6.1 connected to the shell so that the control ratchet needle 6 can rotate around the short shaft 6.1; the length of the lock plate 6.3 is shorter than that of the release plate 6.2.

Preferably, an included angle is arranged between the lock plate 6.3 and the release plate 6.2, and the included angle is an obtuse angle.

Preferably, the limiting mechanism 1.3 is a long elliptical bulge 1.31; one end of the torsional spring 5 is connected to the shell and the other end thereof is fixedly connected to the cam 5; the reset mechanism 7 is a reset cam 7.1 that rotates around a reset shaft 7.2, and one end of the reset shaft 7.2 is connected to the shell and the other end thereof protrudes from the shell 1; the trigger mechanism 8 is a flux transformer 8.6; the shell is further provided with a microswitch 9, and the microswitch 9 is disposed on a side of the reset mechanism 7 close to the lock plate 6.3; a first interlock knob 10 is connected to the spindle 2 protruding from the shell 1, and a second interlock knob 11 is connected to the end of the reset shaft 7.2 protruding from the shell 1.

### Embodiment 2

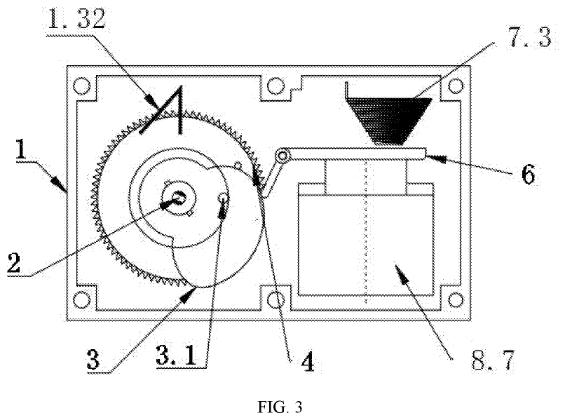

With reference to FIGS. 1, 3, and 7-9, compared with Embodiment 1, the Embodiment differs from Embodiment 1 in that:

the limiting mechanism 1.3 is a brake spring tab 1.31; one end of the torsional spring 5 is connected to the shell and the other end thereof is fixedly connected to the cam 3; the spindle 2 is fixedly connected to the pin of the rotary ratchet 4; the reset mechanism 7 is a reset spring 7.3; the trigger mechanism 8 is an impact electromagnet 8.7.

### Embodiment 3

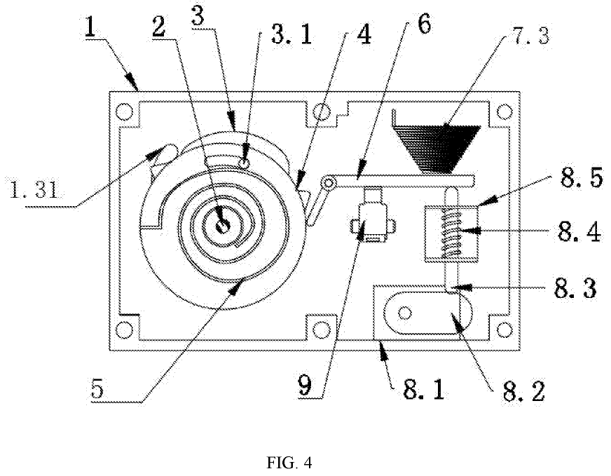

With reference to FIGS. 1, 4, and 7-9, compared with Embodiment 1, the Embodiment differs from Embodiment 1 in that:

the limiting mechanism 1.3 is a long elliptical bulge 1.31; the spindle 2 is connected to the gear of the rotary ratchet 4; one end of the torsional spring 5 is connected to the shell and the other end thereof is fixedly connected to the spindle 2; the reset mechanism 7 is a reset spring 7.3; the trigger mechanism 8 comprises a motor, 8.1 a trigger cam 8.2 connected to the motor 8.1, and a push rod 8.3 connected to the trigger cam 8.2; the outside of the push rod 8.3 is provided with a frame 8.5 for fixing the push rod 8.3, the frame 8.5 is fixedly connected to the shell 1, and the inside of the frame is provided with a trigger spring 8.4 sleeved on the push rod 8.3; the shell 1 is further provided with a microswitch 9, and the microswitch 9 is disposed on a side of the reset mechanism 8 close to the lock plate 6.3.

### Embodiment 4

With reference to FIGS. 1, 5, and 6-9, compared with Embodiment 1, the Embodiment differs from Embodiment 1 in that:

the limiting mechanism 1.3 is a long elliptical bulge 1.31; the spindle 2 is connected to the gear of the rotary ratchet 4; one end of the torsional spring 5 is connected to the shell and the other end thereof is fixedly connected to the cam 3; the reset mechanism 7 is a reset cam 7.1 that rotates around a reset shaft 7.2, and one end of the reset shaft 7.2 is connected to the shell and the other end thereof protrudes from the shell 1; the trigger mechanism 8 is an impact electromagnet 8.7; the microswitch 9 is disposed on a side of the reset mechanism 7 close to the lock plate 6.3; a first interlock knob 10 is connected to the spindle 2 protruding from the shell 1, and a second interlock knob 11 is connected to the end of the reset shaft 7.2 protruding from the shell 1.

### Embodiment 5

With reference to FIGS. 1 and 7-10, compared with Embodiment 4, the Embodiment differs from Embodiment 4 in that:

the reset mechanism 7 is a side wall reset button 7.4 corresponding to an end of the release plate 6.2 of the control ratchet needle 6 away from the lock plate 6.1; one end of the side wall reset button 7.4 protrudes from the shell 1; the side wall reset button 7.4 is sleeved with a side wall reset spring 7.5 connected to the corresponding inner wall of the shell 1, so that the side wall reset button 7.4 is returned to its original position under the action of the reset spring 7.5 after the side wall reset button is pressed in the direction of the trigger mechanism 8.

### Embodiment 6

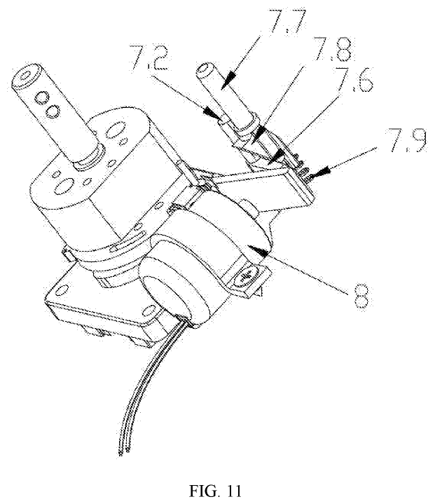

With reference to FIGS. 1, 7-9, and 11, compared with Embodiment 4, the Embodiment differs from Embodiment 4 in that:

the reset mechanism 7 is a reset rotary handle 7.6 that rotates around a reset shaft 7.2;

a top reset button 7.7 on a side of the reset rotary handle 7.6 away from the trigger mechanism 8 is provided in parallel with the spindle 2 and protrudes from the top of the shell 1; the top reset button 7.7 is provided with an inverted triangle driving block 7.8 corresponding to the reset rotary handle 7.6; a top reset spring 7.9 is also sleeved on the bottom of the top reset button 7.7, so that after the top reset button 7.7 is pressed in its setting direction, the inverted triangle drive block 7.8 dials the reset rotary handle 7.6 to rotate toward the trigger mechanism 8 and enables the top reset button 7.7 to be returned to its original position under the action of the top reset spring 7.9; moreover, the connection portion of the reset rotary handle 7.6 and the reset shaft 7.2 is also provided with a rotary handle reset spring, which enables that the reset rotary handle 7.6 to be returned to its original position under no force.

In specific implementation, when the knob of the switch is turned from the OFF position to the ON position, the spindle controls the torsional spring (or volute spiral spring) of the automatic disconnection mechanism, so that the torsional spring (or volute spiral spring) of the automatic disconnection mechanism changes from a relaxed state to a tightened state, thereby completing the energy storage of the torsional spring (or volute spiral spring); at the end of the rotation, the rotary ratchet connected to the spindle is fixed and locked by the control ratchet needle of the disconnection mechanism to prevent it from turning and releasing energy under the great torsion of the torsional spring (or volute spiral spring).

After the energy storage of the torsional spring (or volute spiral spring) is completed, the rotary ratchet is locked by the control ratchet needle and fixed in the energy storage position. When an overload or short circuit occurs in the circuit, the control center can send a signal to the trigger mechanism of the DC switch; after the trigger mechanism is powered, it will immediately fire the action and impact the control ratchet needle to move it away from the rotary ratchet and eventually disengage from it. The rotary ratchet lacks the restriction of the control ratchet needle, and the clockwise rotation thereof is driven by the elastic force of the torsional spring (or volute spiral spring). Since the torque stored by the torsional spring (or volute spiral spring) is greater than the operating torque of the switch spindle, the torsional spring (or volute spiral spring) can drive the switch spindle from the ON position to the OFF position to complete the disconnection operation of the switch.

When the switch needs to be manually disconnected, the spindle of the switch needs to be turned counterclockwise, and the cam fixedly connected to the spindle pin will rotate. This device keeps the rotary ratchet temporarily unrotated within a rotation range of 10 degrees of rotation angle in front of the spindle, but starts to move after the ratchet teeth are pushed apart by the cam, and turns to the off position.

When power is restored after the fault is removed, the automatic disconnection mechanism should be reset first: turning the reset button clockwise can reset it during rotation. The safety of the automatic disconnection mechanism with manual reset operation greatly improves the safety of the equipment, and it must be guaranteed that the fault is removed when a fault is found before the equipment is reset to be put into operation.

The invention and the embodiments thereof have been described above; the description is not restrictive; what have been shown in the drawings are only a few of the embodiments of the invention, and the actual structure is not limited thereto. Any structural manners and embodiments similar to the technical solution of the invention made by those of ordinary skill in the art who are inspired by the invention without creative efforts shall all fall within the protection scope of the invention.

1. An automatic disconnection mechanism for switches, comprising a shell, wherein the inside of the shell is hollow, and the shell is provided with a spindle, a cam sleeved on the spindle, a rotary ratchet sleeved on the spindle, a torsional spring sleeved on the spindle, a control ratchet needle that mates with the rotary ratchet, and a limiting mechanism for limiting the rotation range of the cam; the spindle penetrates the shell and is integrated with the switch shaft; the cam is fixedly connected to the spindle, and one end surface thereof is provided with a guide pin; the rotary ratchet is disposed on a side of the cam on which the guide pin is provided and mates with the hole of the spindle; the torsional spring is disposed on a side of the rotary ratchet and enables the torsional spring to be in a tightened state when the spindle rotates clockwise with the switch shaft; the control ratchet needle is disposed on a side of the rotary ratchet; the control ratchet needle comprises a lock plate and a release plate, and the connection portion of the lock plate and the release plate is sleeved on a short shaft fixedly connected to the shell; the lock plate is arranged corresponding to the outer teeth of the outer edge of the rotary ratchet, so that when the spindle rotates clockwise with the switch shaft, the rotary ratchet is fixed and locked by the lock plate; both sides of the release plate are also provided with a trigger mechanism for impacting the release plate to move the lock plate away from the rotary ratchet and eventually disengaging from the rotary ratchet, and a reset mechanism for returning the release plate to the original position after being impact by the trigger mechanism.

2. The automatic disconnection mechanism for switches according to claim 1, wherein the shell is rectangular parallelepiped, the front end surface thereof is provided with a first cover that mates with the shell, and the rear end surface thereof is provided with a second cover that mates with the shell; the second cover is provided with a second hole that mates with the hole of the spindle.

3. The automatic disconnection mechanism for switches according to claim 1, wherein the rotary ratchet is provided with external teeth that mates with the control ratchet needle on the outer periphery; the rotary ratchet is provided with a long elliptical hole that mates with the guide pin, and the corresponding angle of the long elliptical hole is 10°.

4. The automatic disconnection mechanism for switches according to claim 1, wherein the connection portion of the lock plate and the release plate is provided with a connection shaft hole, and the connection shaft hole is sleeved on the short shaft connected to the shell so that the control ratchet needle can rotate around the short shaft; the length of the lock plate is shorter than that of the release plate, and an included angle is arranged between the lock plate and the release plate, and the included angle is an obtuse angle.

5. The automatic disconnection mechanism for switches according to claim 1, wherein the limiting mechanism is a long elliptical bulge; one end of the torsional spring is connected to the shell and the other end thereof is fixedly connected to the cam; the reset mechanism is a reset cam that rotates around a reset shaft, and one end of the reset shaft is connected to the shell and the other end thereof protrudes from the shell; the trigger mechanism is a flux transformer; the shell is further provided with a microswitch, and the microswitch is disposed on a side of the reset mechanism close to the lock plate; a first interlock knob is connected to the spindle protruding from the shell, and a second interlock knob is connected to the end of the reset shaft protruding from the shell.

6. The automatic disconnection mechanism for switches according to claim 1, wherein the limiting mechanism is a brake spring tab; one end of the torsional spring is connected to the shell and the other end thereof is fixedly connected to the cam; the spindle is fixedly connected to the pin of the rotary ratchet; the reset mechanism is a reset spring; the trigger mechanism is an impact electromagnet.

7. The automatic disconnection mechanism for switches according to claim 1, wherein the limiting mechanism is a long elliptical bulge; the spindle is connected to the gear of the rotary ratchet; one end of the torsional spring is connected to the shell and the other end thereof is fixedly connected to the spindle; the reset mechanism is a reset spring; the trigger mechanism comprises a motor, a trigger cam connected to the motor, and a push rod connected to the trigger cam; the outside of the push rod is provided with a frame for fixing the push rod, the frame is fixedly connected to the shell, and the inside of the frame is provided with a trigger spring sleeved on the push rod; the shell is further provided with a microswitch, and the microswitch is disposed on a side of the reset mechanism close to the lock plate.

8. The automatic disconnection mechanism for switches according to claim 1, wherein the limiting mechanism is a long elliptical bulge; the spindle is connected to the gear of the rotary ratchet; one end of the torsional spring is connected to the shell and the other end thereof is fixedly connected to the cam; the reset mechanism is a reset cam that rotates around a reset shaft, and one end of the reset shaft is connected to the shell and the other end thereof protrudes from the shell; the trigger mechanism is an impact electromagnet; the microswitch is disposed on a side of the reset mechanism close to the lock plate; a first interlock knob is connected to the spindle protruding from the shell, and a second interlock knob is connected to the end of the reset shaft protruding from the shell.

9. The automatic disconnection mechanism for switches according to claim 8, wherein the reset mechanism is a side wall reset button corresponding to an end of the release plate of the control ratchet needle away from the lock plate; the side wall reset button is arranged in the same direction as the trigger mechanism and one end thereof protrudes from the shell; the side wall reset button is sleeved with a side wall reset spring connected to the corresponding inner wall of the shell, so that the side wall reset button is returned to its original position under the action of the reset spring after the side wall reset button is pressed in the direction of the trigger mechanism.

10. The automatic disconnection mechanism for switches according to claim 8, wherein the reset mechanism is a reset rotary handle that rotates around a reset shaft; a top reset button on a side of the reset rotary handle away from the trigger mechanism is provided in parallel with the spindle and protrudes from the top of the shell; the top reset button is provided with an inverted triangle driving block corresponding to the reset rotary handle; a top reset spring is also sleeved on the bottom of the top reset button, so that after the top reset button is pressed in its setting direction, the inverted triangle drive block dials the reset rotary handle to rotate toward the trigger mechanism and enables the top reset button to be returned to its original position under the action of the top reset spring.
